(19) United States
(12) Patent Application Publication
(10) Pub. No.: US 2012/0007975 A1
(43) Pub. Date: Jan. 12, 2012

(54) PROCESSING IMAGE DATA

(76) Inventors: Nicholas P. Lyons, Sunnyvale, CA (US); Tong Zhang, San Jose, CA (US); Niranjan Damera-Venkata, Fremont, CA (US)

(21) Appl. No.: 13/150,826

(22) Filed: Jun. 1, 2011

Related U.S. Application Data
(60) Provisional application No. 61/350,471, filed on Jun. 1, 2010.

(51) Int. Cl. G06K 9/00; H04N 7/18

(52) U.S. Cl. 348/77; 382/115; 348/E07.085

(57) ABSTRACT

Systems and methods are provided for identifying an image having a target individual therein. An example system includes an image capture system that generates image data representing a set of a captured images of a predetermined area, an image database that stores the image data, a feature information database that stores feature information for identifying a person caught in an image as the target individual, a target individual image database that stores exemplar image data representing an image of the individual, and a processing subsystem for processing the image data to detect the target individual using the feature information and the exemplar image data.

### CROSS-REFERENCE TO RELATED APPLICATIONS

This patent application claims priority to U.S. application No. 61/350,471, titled “Processing Image Data,” filed Jun. 1, 2010, which is incorporated by reference in its entirety for the disclosed subject matter as though fully set forth herein.

### BACKGROUND

Locating an individual in a large crowd over a large geographic area is an expensive manual task. It can take hours to days to assemble a manual search team and in many circumstances the delay may frustrate efforts to locate the individual and make it very difficult if not accomplished within a shorter time frame. When using a manual search team there can be a long delay in requesting, informing and transporting search personnel to the required search location. A delay of this nature at the search's start can increase the difficulty of the search (for example, an individual can roam further away or leave the monitored area) or in some cases reduce the value of locating the target (e.g., if the individual requires immediate medical assistance or could perish due to deteriorating weather conditions).

There are automated solutions for search. For example, face detection can be used to compare a prior exemplar image of the target individual with still images obtained from still or video cameras whose outputs are analyzed to look for people similar to the exemplar image. However, face detection can be computationally expensive requiring a tradeoff between the amount of computing resources and the time required for detection. Also face detection works best when an individual faces the camera with no horizontal or vertical rotation. In uncontrolled conditions it is not always possible to capture ideal images of all people in the monitored area, hence some people would escape detection.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is an example functional block diagram depicting an architecture of a computing apparatus;

FIG. 2 is an example schematic representation of a network of digital image capture devices;

FIG. 3 is a further example schematic representation of a network of digital image capture devices imaging a crowd of people including a target individual; and

FIG. 4 is an example schematic representation of data used to generate a perceptual hash code for a target individual.

FIG. 5 shows a flow chart of an example process for identifying an image that includes a target individual.

### DETAILED DESCRIPTION

Reference will now be made in detail to certain implementations, examples of which are illustrated in the accompanying drawings. In the following detailed description, numerous specific details are set forth in order to provide a thorough understanding of the implementations. Well-known methods, procedures, components, circuits, and networks have not been described in detail so as not to unnecessarily obscure aspects of the implementations.

It will also be understood that, although the terms first, second, etc. may be used herein to describe various elements, these elements should not be limited by these terms. These terms are only used to distinguish one element from another. For example, a first item could be termed a second item, and, similarly, a second item could be termed a first item.

The terminology used in the description herein is for the purpose of describing particular examples only and is not intended to be limiting. As used in the description the subject matter and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

An “image” broadly refers to any type of visually perceptible content that may be rendered on a physical medium (e.g., a display monitor or a print medium). Images may be complete or partial versions of any type of digital or electronic image, including: an image that was captured by an image sensor (e.g., a video camera, a still image camera, or an optical scanner) or a processed (e.g., filtered, reformatted, enhanced or otherwise modified) version of such an image; a computer-generated bitmap or vector graphic image; a textual image (e.g., a bitmap image containing text); and an iconographic image.

A “computer” is any machine, device, or apparatus that processes data according to computer-readable instructions that are stored on a computer-readable medium either temporarily or permanently. A “software application” (also referred to as software, an application, computer software, a computer application, a program, and a computer program) is a set of machine-readable instructions that a computer can interpret and execute to perform one or more specific tasks. A “data file” is a block of information that durably stores data for use by a software application.

The term “computer-readable medium” refers to any medium capable storing information that is readable by a machine (e.g., a computer system). Storage devices suitable for tangibly embodying these instructions and data include, but are not limited to, all forms of non-volatile computer-readable memory, including, for example, semiconductor memory devices, such as EPROM, EEPROM, and Flash memory devices, magnetic disks such as internal hard disks and removable hard disks, magneto-optical disks, DVD-ROM/RAM, and CD-ROM/RAM.

As used herein, the term “includes” means includes but not limited to, the term “including” means including but not limited to. The term “based on” means based at least in part on.

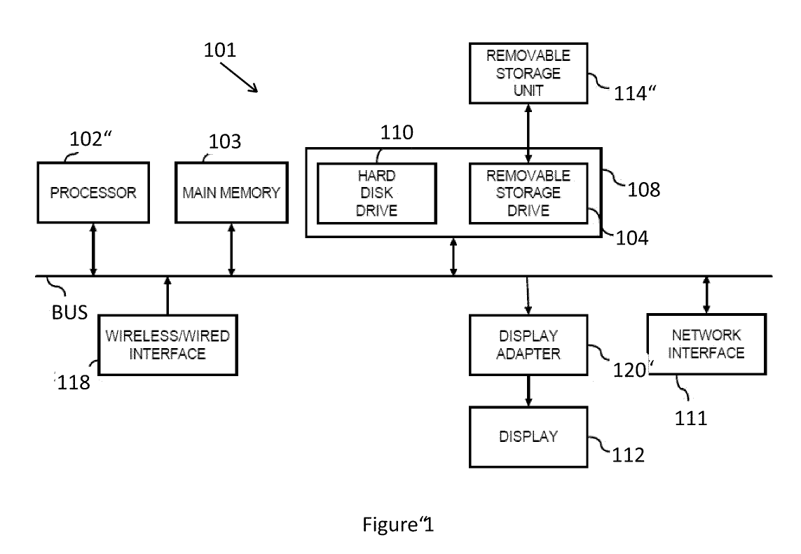

FIG. 1 is a functional block diagram depicting an architecture of a computing apparatus 101 suitable for use in the process according to certain implementations. The apparatus comprises a data processor 102, which can include one or more single-core or multi-core processors of any of a number of computer processors, such as processors from Intel, AMD, and Cyrix for example. As referred to herein, a computer processor may be a general-purpose processor, such as a central processing unit (CPU) or any other multi-purpose processor or microprocessor. The processor 102 comprises one or more arithmetic logic units (not shown) operable to perform operations such as arithmetic and logical operations of the processor 102.

Commands and data from the processor 102 are communicated over a communication bus or through point-to-point links (not shown) with other components in the apparatus 101. More specifically, the processor 102 communicates with a main memory 103 where machine readable instructions, including software, can be resident during runtime. A secondary memory (not shown) can be used with apparatus 101. The secondary memory can be, for example, a computer-readable medium that may be used to store software programs, applications, or modules that implement examples of the subject matter, or parts thereof. The main memory 103 and secondary memory (and optionally a removable storage unit 114) each includes, for example, a hard disk drive 110 and/or a removable storage drive such as 104, which is a storage device connected to the apparatus 101 via a peripherals bus (such as a PCI bus for example) and representing a floppy diskette drive, a magnetic tape drive, a compact disk drive, etc., or a non-volatile memory where a copy of the software is stored. In one example, the secondary memory also includes ROM (read only memory), EPROM (erasable, programmable ROM), EEPROM (electrically erasable, programmable ROM), or any other electronic, optical, magnetic, or other storage or transmission device capable of providing a processor or processing unit with computer-readable instructions. Apparatus 101 can optionally comprise a display 112 connected via the peripherals bus (such as a PCI bus) for example, as well as user interfaces comprising one or more input devices, such as a keyboard, a mouse, a stylus, and the like. A network interface 111 can be provided for communicating with other computer systems via a network.

Implementations can be executed by a dedicated hardware module, such as an ASIC, in one or more firmware or software modules, or in a combination of the same. A firmware example would typically comprise instructions, stored in non-volatile storage, which are loaded into the CPU 102 one or more instructions at a time for example. A software example would typically comprise one or more application programs that is/are loaded from secondary memory into main memory 103, when the programs are executed. The apparatus of figure can be in the form of a server whose primary function is the storage and processing of bulk amount of data for example. Accordingly, certain ones of the components can be ‘server grade’ such that any one or more of lifespan, processing capability, storage capacity, and HDD access read and write times for example are maximized or otherwise within desired parameters.

According to an implementation, a set of distributed camera sensors are used in order to speed up the task of narrowing down the location of a target individual to a smaller portion of a search area such that fewer search personnel are required to achieve the same result as if a larger, but undirected, search team had been used. An implementation can be used to locate a missing child at an amusement park, a person needing assistance who is incapacitated, or who has wandered away from an area and become lost, or a criminal attempting to hide in a monitored location (such as buildings, sporting events, concerts, city centers, airports, etc.) for example, although it will be appreciated that other uses are possible. Accordingly, if installed in a monitored location, an implementation for locating a target individual or individuals is able to start producing candidate individuals and their locations as soon as search criteria are entered into the system.

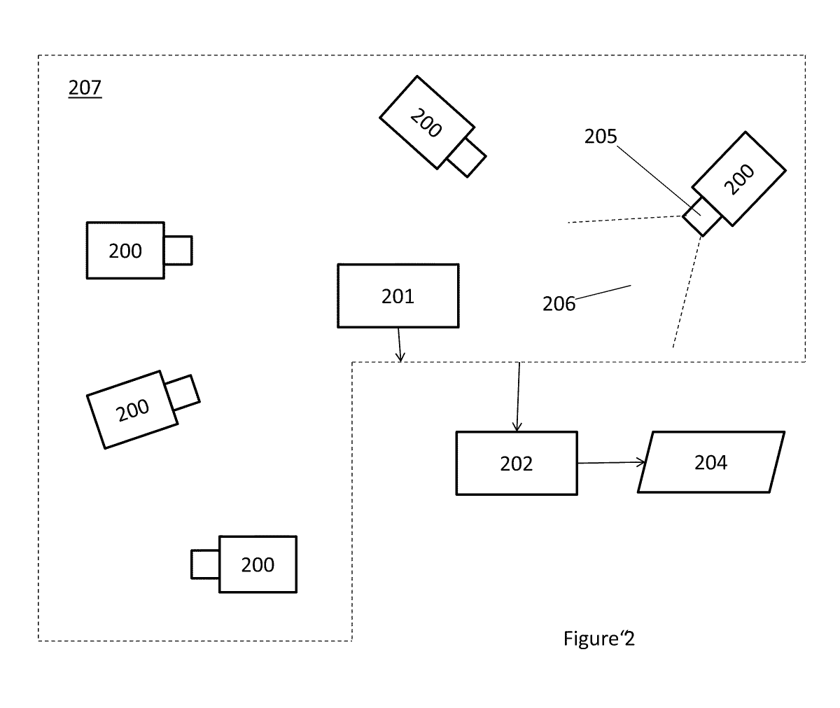

FIG. 2 is a schematic representation of a network of digital image capture devices distributed over a geographic, and linked to a central storage and processing subsystem. A plurality of digital image capture devices 200 generate image data representative of still or video images from a field of view of the device. Accordingly, devices 200 can be still or video image capture devices, wherein the latter can be a device operable to capture an image at predetermined intervals (such as 1 second for example). Devices 200 can be networked together (not shown), and/or networked to a routing subsystem 201 from transmission of image data from the devices to a storage and processing subsystem 202. Alternatively, devices 200 can be individually connected to subsystems 201 or directly to 202. Other alternatives are possible as will be appreciated.

With reference to FIG. 2, a lens 205 of a device 200 has a field of view depicted generally by 206. Such details are not shown for all devices of figure so as to not unnecessarily obscure the figure, however, it will be appreciated that devices 200 can all have a similar, identical or differing field of view in order to image a desired area of a region to be monitored 207. Data received at a storage and processing subsystem 202 is processed in order to provide preprocessed image data 204 as will be described in more detail below.

According to an implementation there is provided a hierarchical computer implemented system that allows several image analysis and object detection techniques to be employed, wherein inexpensive feature detection methods are used initially and more expensive feature detection techniques are performed later. Accordingly, search speed and a high recall rate is primary, whereas search precision is a secondary, although important, consideration. An objective of the system is to quickly identify possible candidates matching the target individual's description along with the sensor location where the candidate was detected and return that information to a search team.

Inputs to a system according to an example are:

Target person image(s)—more specifically, one or more pictures of the target individual such as photographs (scanned in by the system) or read from a memory card from a still or video camera by a person associated with the target individual (such as a family member or friend for example). Note that if pictures taken of the target today are available with the target wearing the same clothes this is very valuable exemplar data for inputting to the system;
Textual description—more specifically, a description of the individual is provided during a manual search (such as for example: “4 foot 8 inches tall white male wearing a red shirt and blue shorts and a white hat”);
Image input—images from still cameras or frames extracted from video cameras 200 positioned in the vicinity of the monitored area 207 (the location of the cameras and time stamping of images can be provided either by the devices themselves or when image data is received by subsystems 201 or 202).

An implementation uses a hierarchical search procedure. Accordingly, a search is initiated with the fastest technique for computing image searches, combining results with multiple search techniques and progressing to more computationally expensive search techniques to focus expensive manual search resources to the location and candidates with the highest probability for search success. Multiple search techniques can indicate multiple candidates in different locations with differing probabilities of confidence. The intersection of different techniques' candidate sets can be used to increase confidence in candidates identified multiple times. Manual search personnel can be allocated to locations that contain more candidate results and candidates of higher probabilities. In the search procedure a scope of location is initially determined based on prior knowledge of the target individual. For example, if a lost child was seen somewhere 10 minutes ago, then he/she should be within a certain distance from that place. Photo/video frames taken within that scope during the last 10 minutes are provided as the source material. Such time/location criteria can greatly limit the amount of images to analyze, and thus help limit a computational workload.

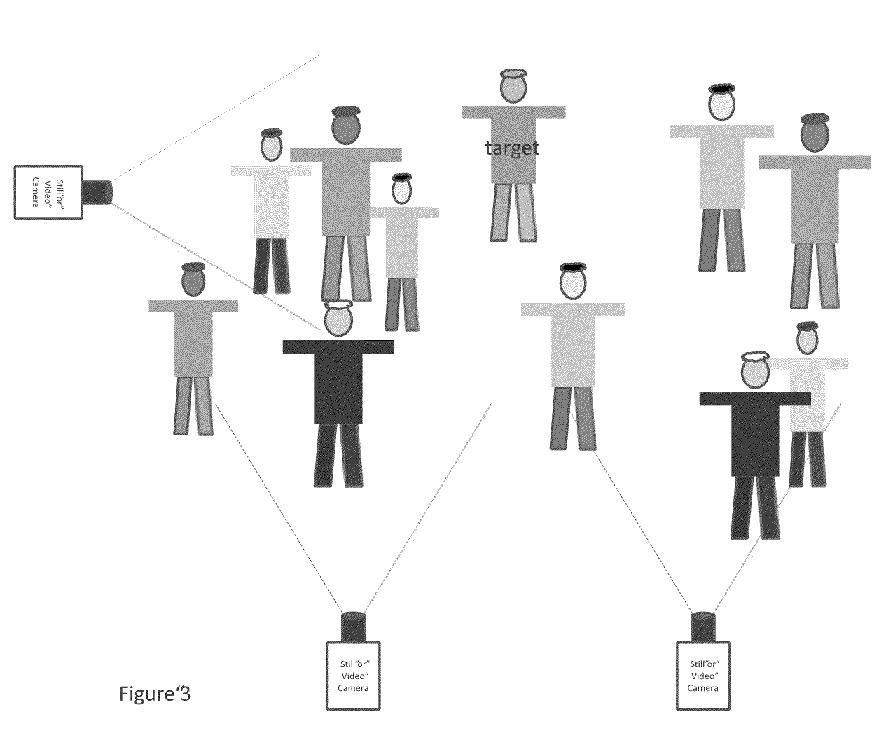

FIG. 3 is a further schematic representation of a network of digital image capture devices imaging a crowd of people including a target individual. A set of features of the target person can be derived from a query image(s) and a verbal description. Accordingly, a set of features can comprise: one or more facial feature vectors, one or more clothes feature vectors, one or more hair feature vectors, age, gender, etc. The following image analysis techniques may be used for the search: face detection, human body detection, age estimation, gender estimation, face recognition, hair feature matching, clothes feature matching, etc. For images (including photos and video frames) in the search scope, a quick screening can first be applied using human body detection and clothes feature matching. Candidate regions in images that may contain the target person can thus be obtained. Face detection and hair feature matching may be applied next to confirm the presence of a candidate person. If a face can be detected, age/gender estimation can be done to further screen out false positives; and finally face recognition can be conducted to provide more evidence. If a face cannot be detected, a confidence score can be computed by integrating body detection, clothes matching and hair matching results. Overall, a ranking list can be generated for the candidates to be presented to the searching team which includes all candidates (inclusive) and is in order of closeness to the query (efficient). By browsing through pictures of the candidates in order, the search team may quickly identify the target person if he/she is captured in images in the search scope. With reference to FIG. 3, the color of the skin, hair, and clothes of the target, amongst other parameters, can be used to locate them. More specifically, in a field of view of a still or video camera, images of the target can be captured. The resultant image data can be used to extract features of the target which can be matched against exemplar data in order to detect matches for the target from a group of people within a crowd of people for example.

A method for using clothing information of a target individual in order to identify that individual in images in which a face detector has failed to identify the individual is described in the Applicant's co-pending U.S. patent application Ser. No. 12/791,680, attorney docket no. 200904220-1, the contents of which are incorporated herein by reference in their entirety. Accordingly, a method for determining one or more hair, skin and clothing signatures of a target individual is described. Determined signatures can be used to provide a match for an individual. In the present system, all or some of the skin, hair and clothing signatures can be used to provide matches.

Moving body detection relative to foreground-background separation is described. Individual detection and separation of a person from the background of an image can be computationally expensive, but if the software has access to live video frames or a succession of stored frames it is less computationally expensive to detect object motion in or between frames. Once a moving object is detected, a human body detector can be applied to the moving object image and compared to the exemplar image data to match the color of the hair area, the face area, the shirt or torso area, and the leg area of the two images. If the correlation between the two images is high then the system has detected a candidate for a good match.

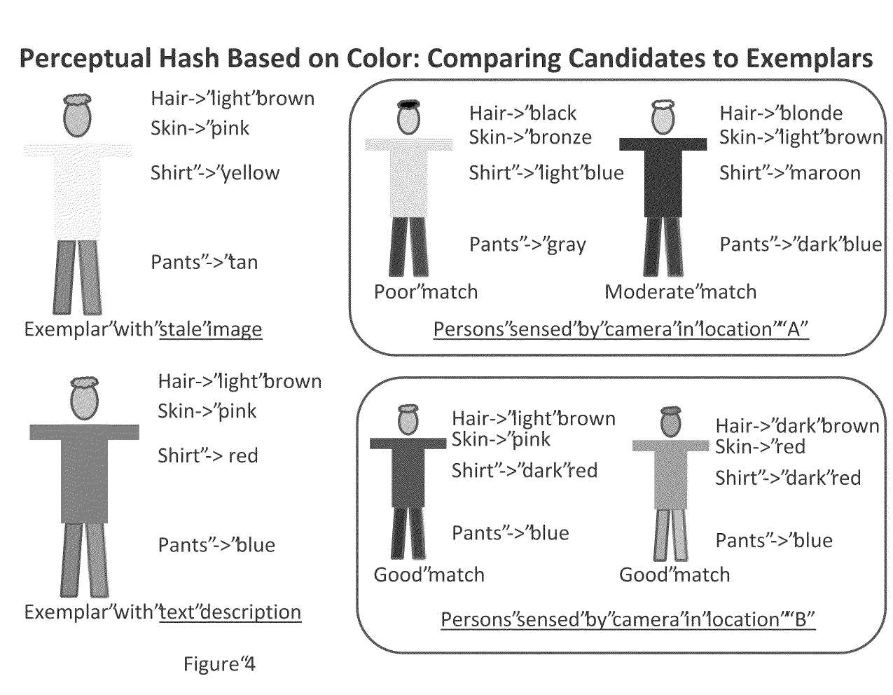

FIG. 4 is a schematic representation of data used to generate a perceptual hash code for a target individual. More specifically, once an area of an image is known to contain a person, a spatial filter can be applied to extract the color (and texture) of the main body parts corresponding to the hair color, face color, shirt or torso color, legs or pants color. These colors can be used to create a perceptual hash code that identifies the targeted individual and may be correlated with the input image of the individual. If the input image was taken on the same day, then the weighting associated with the shirt and pants color, for example, can be increased as opposed to a photo of the individual taken in the past where the clothing being worn may not match what the person was wearing today. If the extracted clothing and hair colors can be mapped to a color identifier or color family (i.e. “royal blue”, “ivory”, “red”, “dark green”, etc.), the extracted color identifiers can be correlated with the textual description of the targeted individual. Note that the processing is performed coarse to fine for speed and the results are presented from fine to coarse to maximize recall and minimize photos that need to be matched by human eyes.

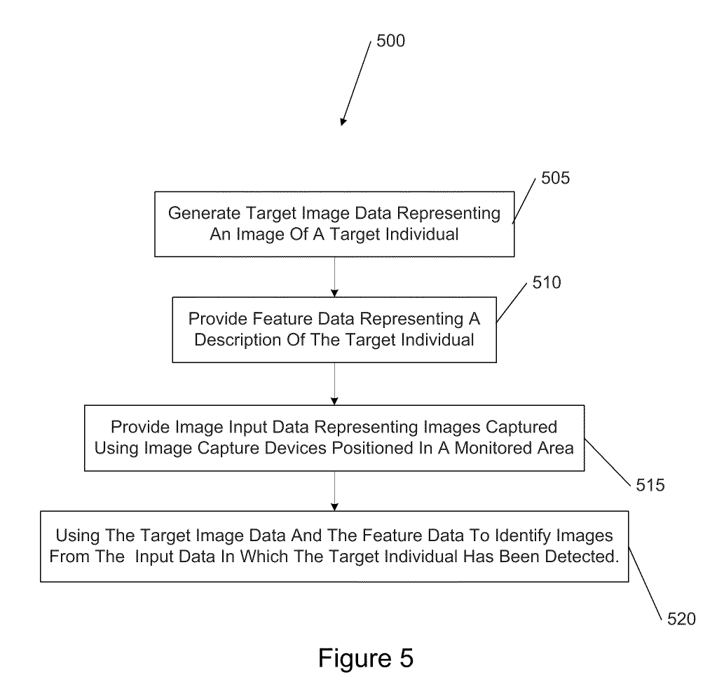

FIG. 5 shows a flow chart of an example process 500 for identifying an image that includes a target individual. The processes of FIG. 5 can be performed using systems as described in the examples of FIGS. 1 to 2. In block 505, target image data representing an image of a target individual is generated. In block 510, feature data representing a description of the target individual is provided. In block 515, image input data representing images captured using image capture devices positioned in a monitored area is provided. In block 520, the target image data and the feature data are used to identify images from the input data in which the target individual has been detected.

A hierarchical approach is thus provided, which enables a target person to be located utilizing several image search techniques to examine the output of cameras monitoring crowds of people in multiple related locations. The analyses of image features by several automatic systems offer a means to achieve superior performance in both speed and accuracy.

Many modifications and variations of this invention can be made without departing from its spirit and scope, as will be apparent to those skilled in the art. The specific examples described herein are offered by way of example only, and the invention is to be limited only by the terms of the appended claims, along with the full scope of equivalents to which such claims are entitled.

As an illustration of the wide scope of the systems and methods described herein, the systems and methods described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

What is claimed is:

1. An image processing system for identifying an image having a target individual therein, comprising:
an image capture system that generates image data representing a set of a captured images of a predetermined area;
an image database that stores the image data;
a feature information database that stores feature information for identifying a person caught in an image as the target individual;
a target individual image database that stores exemplar image data representing an image of the individual; and
a processing subsystem for processing the image data to detect the target individual using the feature information and the exemplar image data.

2. The image processing system of claim 1, further comprising using the location of the area and a time of capture of the image data in order to provide an indication of an area where the target individual is present.

3. A method for image processing, comprising:
generating target image data representing an image of a target individual;
providing feature data representing a description of the target individual;
providing image input data representing images captured using image capture devices positioned in a monitored area; and
using the target image data and the feature data to identify images from the input data in which the target individual has been detected.

4. The method of claim 3, further comprising using the location of the area and a time of capture of the image data in order to provide an indication of an area where the target individual is present.
